(19) United States
(12) Patent Application Publication
(10) Pub. No.: US 2025/0315364 A1
(43) Pub. Date: Oct. 9, 2025

(54) FAST TEST DISABLEMENT FOR PULL REQUEST AND CONTINUOUS INTEGRATION WORKFLOWS

(71) Applicant: Microsoft Technology Licensing, LLC, Redmond, WA (US)

(72) Inventors: Bharat KANDOI, Kirkland, WA (US); Nolan David GLORE, Seattle, WA (US); Sandeep KUMAR, Snohomish, WA (US); Derek Andrew PARK, Seattle, WA (US); Joshua Caleb GREEN, Kirkland, WA (US)

(73) Assignee: Microsoft Technology Licensing, LLC, Redmond, WA (US)

(21) Appl. No.: 18/625,428

(22) Filed: Apr. 3, 2024

(51) Int. Cl. G06F 11/36

(52) U.S. Cl. CPC G06F 11/368

(57) ABSTRACT

A data processing system implements after determining that a test in a target branch of a code repository starts failing, receiving a pull request (PR) onto the target branch and blocking the PR (invoking a build policy and a test policy); after determining that the failing test in the target branch is disabled, tracking the disabled test in a disabled test file; in response to a request to requeue the test policy, determining whether artifact in the build policy is identical with artifact in the test policy; when not identical, fetching all versions of the file within a time period, generating a union content of all versions of the file, and applying the requeued test policy using the union content, the time period being between a start time of the build policy and a start time of the requeued test policy; and unblocking the PR.

### BACKGROUND

Code development is an important task for many organizations. Collaboration in performing code development has become more prevalent. As such, it has become increasingly desirable in many cases to track the history and progression of the code. For example, a code repository (e.g., a distributed version control system (DVCS)) typically has one target branch that often holds the most recent stable and functional version of the codebase, every developer working on the codebase has a complete copy of the target branch and its history on their machine, and the developer can make changes freely on a feature branch without affecting other feature branches. Meanwhile, a continuous integration (CI) workflow automatically builds and tests code every time a team member commits code changes for version control. However, in the code repository, when a test on the target branch starts failing, all changes into the target branch (including pull requests) are blocked either completely blocked or intermittently blocked (depending on whether the test is failing 100% of the time or exhibits intermittent failures). To unblock the changes to the target branch, someone needs to manually investigate and resolve failing test(s). The person needs to review the test logs and error messages to understand the failure's nature; examine recent code changes, build pipeline logs, test environment logs for potential clues; analyze potential causes; perform root cause analysis, and then implement a solution. This is a tedious task that can take many hours. Hence, there is a need for improved systems and methods for handling failed test(s) in code development and unblocking the team project.

### SUMMARY

An example data processing system according to the disclosure includes a processor and a machine-readable medium storing executable instructions. The instructions when executed cause the processor alone or in combination with other processors to perform operations including tracking one or more disabled tests associated with a target branch of a code repository in a disabled test file; after determining that a test in the target branch starts failing, receiving from a user device a pull request onto the target branch and blocking the pull request, the pull request invoking a build policy and a test policy; after determining that the failing test in the target branch is disabled, tracking the disabled test in the disabled test file; in response to a request from the user device to requeue the test policy received after the disabled test is tracked in the disabled test file, determining whether artifact in the build policy is identical with artifact in the test policy, when it is determined that the artifact in the build policy is identical with the artifact in the test policy, fetching from a code repository a latest version of the disabled test file, and applying the requeued test policy using the latest version of the disabled test file as a source of truth to disable and suppress tests in the code repository; or when it is determined that the artifact in the build policy is not identical with the artifact in the test policy, fetching from the code repository all versions of the disabled test file within a time period, generating a union content of all versions of the disabled test file, and applying the requeued test policy using the union content as a source of truth to disable and suppress tests in the code repository, the time period being between a start time of the build policy and a start time of the requeued test policy; and unblocking the pull request.

An example method implemented in a data processing system includes tracking one or more disabled tests associated with a target branch of a code repository in a disabled test file; after determining that a test in the target branch starts failing, receiving from a user device a pull request onto the target branch and blocking the pull request, the pull request invoking a build policy and a test policy; after determining that the failing test in the target branch is disabled, tracking the disabled test in the disabled test file; in response to a request from the user device to requeue the test policy received after the disabled test is tracked in the disabled test file, determining whether artifact in the build policy is identical with artifact in the test policy, when it is determined that the artifact in the build policy is identical with the artifact in the test policy, fetching from a code repository a latest version of the disabled test file, and applying the requeued test policy using the latest version of the disabled test file as a source of truth to disable and suppress tests in the code repository; or when it is determined that the artifact in the build policy is not identical with the artifact in the test policy, fetching from the code repository all versions of the disabled test file within a time period, generating a union content of all versions of the disabled test file, and applying the requeued test policy using the union content as a source of truth to disable and suppress tests in the code repository, the time period being between a start time of the build policy and a start time of the requeued test policy; and unblocking the pull request.

An example non-transitory computer readable medium according to the disclosure on which are stored instructions that, when executed, cause a programmable device to perform functions of tracking one or more disabled tests associated with a target branch of a code repository in a disabled test file; after determining that a test in the target branch starts failing, receiving from a user device a pull request onto the target branch and blocking the pull request, the pull request invoking a build policy and a test policy; after determining that the failing test in the target branch is disabled, tracking the disabled test in the disabled test file; in response to a request from the user device to requeue the test policy received after the disabled test is tracked in the disabled test file, determining whether artifact in the build policy is identical with artifact in the test policy, when it is determined that the artifact in the build policy is identical with the artifact in the test policy, fetching from a code repository a latest version of the disabled test file, and applying the requeued test policy using the latest version of the disabled test file as a source of truth to disable and suppress tests in the code repository; or when it is determined that the artifact in the build policy is not identical with the artifact in the test policy, fetching from the code repository all versions of the disabled test file within a time period, generating a union content of all versions of the disabled test file, and applying the requeued test policy using the union content as a source of truth to disable and suppress tests in the code repository, the time period being between a start time of the build policy and a start time of the requeued test policy; and unblocking the pull request.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The drawing figures depict one or more implementations in accord with the present teachings, by way of example only, not by way of limitation. In the figures, like reference numerals refer to the same or similar elements. Furthermore, it should be understood that the drawings are not necessarily to scale.

FIGS. 1A-1B are diagrams of an example computing environment in which the techniques for providing fast test disablement for pull request and continuous integration workflows are implemented.

FIG. 2 is a conceptual diagram of the fast test disablement for pull request and continuous integration workflows of the system of FIGS. 1A-1B.

FIGS. 3A-3B are example user interfaces of a fast test disablement solution that implements the techniques described herein.

FIG. 4 is a flow chart of an example process for providing fast test disablement for pull request and continuous integration workflows according to the techniques disclosed herein.

FIG. 5 is a block diagram showing an example software architecture, various portions of which may be used in conjunction with various hardware architectures herein described, which may implement any of the described features.

FIG. 6 is a block diagram showing components of an example machine configured to read instructions from a machine-readable medium and perform any of the features described herein.

### DETAILED DESCRIPTION

When a test fails in a continuous integration (CI) system, several key actions take place. The pipeline execution halts to prevent potentially broken code from progressing further into the development process. The CI system alerts the project team about the failed test including details like which test(s) failed, the specific error messages, and even logs or screenshots from the test run. The relevant developer or an on-call engineer (OCE) then investigates the cause of the failure and implement a fix. If the fix involved changes to the code that directly affects the build artifact (e.g., compiled code, packaged application, or the like), the CI system automatically re-triggers the build process as part of the re-run. If the changes do not modify the build process itself, the developer/OCE may need to manually initiate a rebuild after the tests pass to ensure the artifact reflects the latest code revisions. The current way of disabling failing tests is too slow since it requires such regeneration of build artifact. In a big code repository like the one of Microsoft SharePoint Online®, when a test starts failing, it blocks the entire project team from completing their pull requests (PRs). To unblock the project team, an OCE needs a fast way to disable the failing test without having to run all PR/CI policies. The system developed by the inventors introduces a fast test disablement solution that enables developers to quickly disable their tests for all PRs and CI pipelines for the code repository and branch.

Systems and methods for fast test disablement for pull request and continuous integration workflows are described herein. These techniques provide a technical solution to the technical issues that arise when a test on one branch starts failing in a PR workflow or a CI workflow, the relevant software development platform blocks the changes to the target branch after a failed test on the target branch, and waits for the developer or an OCE to respond to the failed test and determine the cause of the failure. Once the developer/OCE responds, they can manually disable the tests, or revert a change if a build is faulty. As mentioned, the developer/OCE manually investigates and resolves failing tests and then unblocks the whole code repository, which is tedious and time-consuming. The system developed by the inventors tracks disabled tests associated with the code repository and records disabled tests in a disabled test file checked in a given code repository, then utilizes the disabled test file as a source of truth for quickly disabling and suppressing tests, and then unblocking the PR/CI workflow(s). The failed tests are left to be fixed by another system later.

The system disables and suppresses failing tests based a latest version or a union content of the disabled test file, so other developers can work as usual. In other words, the system uses the disabled test file to decide which tests to skip. As a result, the system will not run those tests because the system is aware of and skips the failed test and understands there is no fix for them at the time. Once the system downloads the disabled test file which is newly merged with all the union content, as discussed, the system will not run those tests and the developers' PRs will no longer fail because the problematic failed tests will not run in their PRs. Therefore, the developers' pull request policies will pass and they will be able to merge their PRs into the main branch.

Although various embodiments are described with respect to DevOps pipelines (e.g., Azure DevOps pipelines), it is contemplated that the approach described herein may be used with any software development platforms.

A technical benefit of the approach provided herein is a fast way for a developer/OCE to disable tests for a given code repository and branch, thereby increasing productivity and shortening release cycles. Another technical benefit of this approach is re-enablement of tests thereby allowing a test author to execute the respective test in the same pull requests. Another technical benefit of this approach is re-enablement of tests with a code fix, without failing other active pull requests.

Another technical benefit of this approach is a disabled test file checked in a version control repository that is usable by any version control systems.

Another technical benefit of this approach is real-time or substantially real-time tracking of disabled tests in a disabled test file and real-time or substantially real-time fetching of the disabled test file to unblock PR and CI workflows for developers, even if the developers are using an old build that has the test enabled. This saves time for developers to get the disabled test list embedded in the disabled test file without wasting time in remerging and requeuing new builds for the disabled test list.

Another technical benefit of this approach is reenabling tests without blocking active PR or CI workflows that do not have the test fix, by using a union logic to determine if the build or CI workflow contains the fix, which saves developers time in remerging and obtaining new builds.

Another technical benefit of this approach is in scenarios where the disabled test file is changed by a developer in a pull request. This approach applies user intent of changes to the disabled test file in addition to the union logic to correctly infer which test needs to be enabled and disabled.

Another technical benefit of this approach is the ability to disable tests in past and future builds across all branches of a code repository. These and other technical benefits of the techniques disclosed herein will be evident from the discussion of the example implementations that follow.

As used herein, the term “build” refers to the process of taking source code and transforming it into an executable program or deployable unit. This typically involves compiling, linking, and performing other potential steps on source code, depending on the project and language. A build artifact is the output of a successful build process. It is typically an executable file, library, deployment package, or any other deliverable specific to a project.

Continuous integration (CI) is the process of automatically building and testing code one build at a time. Typically, CI starts the next build when the current build completes. When many commits come in, CI puts the commits into the next build. For example, the types of tests can include unit tests, integration tests, end-to-end tests, and additional tests specific to the project, such as performance or security tests. These tests run automatically as part of the build pipeline for a branch to promote continuous feedback and early detection of regressions. A unit test tests individual units of code (functions, classes, etc.) to ensure they are working as expected. An integration test tests how different components of the code interact with each other. An end-to-end test tests the entire journey and functionality of a feature.

A code commit to the main or trunk branch of a shared code repository triggers the automated build system to build, test, and validate the full branch. Build definitions specify that every commit to the main branch triggers the automated build and testing process. Automated tests verify that every build maintains consistent quality. A main or master branch is the default branch in many version control systems, and it accepts merged changes that are reviewed and approved. A feature branch is usually named after the feature or bug it addresses, like feature/new-login-system or bugfix/crash-on-startup. A feature branch is created from the main or dedicated development branch, and it is merged into the main or designated development branch after completion and review. A release branch is usually named after the version it represents, such as release/v1.2.0., and it is created from the main or designated development branch. A release branch may be merged back into other release branches if needed. CI is a standard feature in modern software development platforms.

By way of example, CI merges developers' changes into the shared version control repository every time they complete a task. CI keeps the main branch up-to-date. Developers can use modern version control systems like Git to isolate their work in short-lived feature branches. When the feature is complete, the developer submits a PR from the feature branch to the main branch. On approval of the PR, the changes merge into the main branch, and the feature branch can be deleted.

A “pull request” or PR is a mechanism for proposing changes to a codebase in a shared code repository. It is created after a developer working on a feature branch submits the feature branch to the main branch (usually called master or main) for review and merging. Other team members can review and/or discuss the changes, then approve or reject the changes for integration into the main codebase. A pull request typically includes a title, description, and details about the changes made by the developer.

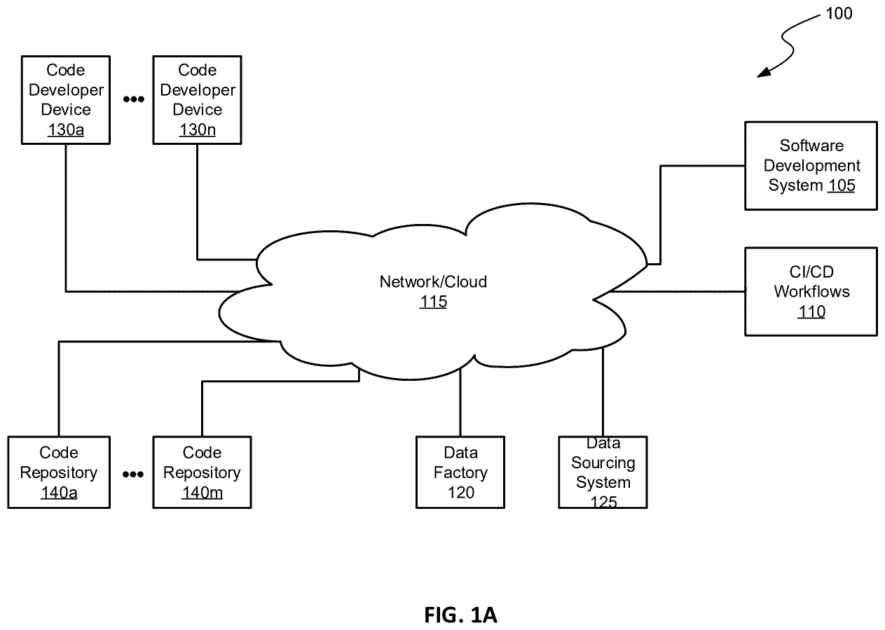

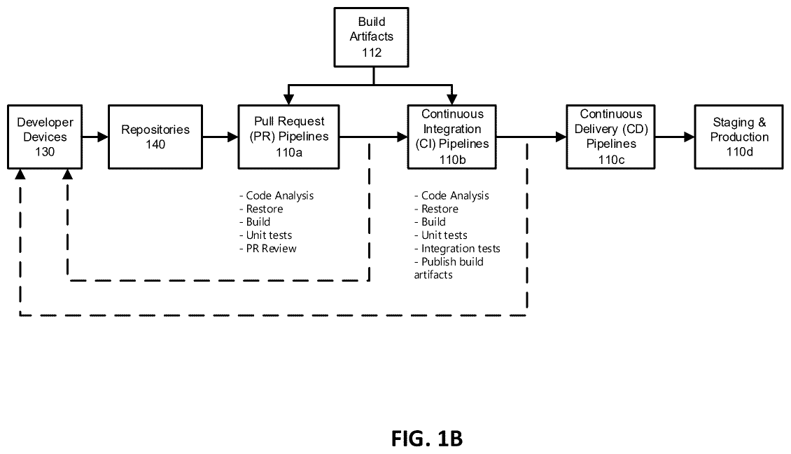

FIG. 1A is a block diagram illustrating an example of an application services platform 100. The application services platform 100 may include a software development system 105, Continuous Integration/Continuous Delivery (CI/CD) workflows 110, a network 115 (e.g., including a cloud), a data factory 120, a data sourcing system 125, as well as code developer devices 130a-130n (collectively referred to as developer devices 130, e.g., desktops, laptops, smart phones, etc.) and code repositories 140a-140m (also collectively referred to as code repositories 140) which, in some examples, all connect to the network 115.

Each of the developer devices 130, the code repositories 140, the data factory 120, the data sourcing system 125, the software development system 105, and the CI/CD workflows 110 use on-premises or cloud-based infrastructure. For example, the hardware for implementing the CI/CD workflows 110 depends on several factors, such as the type of CI/CD tool used, whether using on-premises or cloud-based infrastructure, or the like. The fast test disablement solution can use one or more computing devices to run the CI/CD workflows 110, one or more storage mediums to store source code, build artifacts, and test results, and a reliable network to connect the servers, build agents, and test runners. In one embodiment, the hardware for implementing the CI/CD workflows 110 stands alone. In another embodiment, the hardware for implementing the CI/CD workflows 110 is embodied in an existing system, such as the software development system 105.

The computing devices may include virtually any type of general- or specific-purpose computing devices with data processing units. For example, a computing device may be a user device such as a desktop computer, a laptop computer, a tablet computer, a display device, a camera, a printer, or a smartphone. Likewise, a computing device may also be a server device such as an application server computer, a virtual computing host computer, or a file server computer. Likewise, the computing device may be an example of any of the devices, a device within any of the distributed systems, illustrated in or referred to in any of the following figures, as discussed in greater detail below.

FIG. 1A and the corresponding description of FIG. 1A in the specification illustrate an example system for illustrative purposes that does not limit the scope of the disclosure. The code repositories 140, the data factory 120, the data sourcing system 125, the software development system 105, and the CI/CD workflows 110 may each be a part of one or more distributed systems.

The software development system 105 provides tools and services for the entire software development lifecycle, from planning and coding to testing and deployment. It aims to streamline and accelerate the development process by offering a unified and integrated set of functionalities. The software development system 105 can be DevOps-focused or a development platform (SDP), or use an SDP that supports DevOps principles for a comprehensive solution.

The CI/CD workflows 110 implement a software development approach where all developers work together on a shared code repository of code, and as changes are made, there are automated build processes for detecting code issues. The outcome is a faster development life cycle and a lower error rate. In one embodiment, the CI/CD workflows 110 adapts generic PR/CI/CD pipelines. FIG. 1B illustrates example PR/CI/CD pipelines for illustrative purposes and does not limit the scope of the disclosure.

For instance, the PR pipelines 110a builds, unit-tests, and validates code before allowing a PR to merge with a main branch, and then the CI pipelines 110b is run after the code is merged into the main branch. The CI pipelines 110b perform the same validation as the PR pipelines 110a, yet add integration testing, and publish build artifacts 112 when the integration testing succeeds. The CD pipelines 110c deploy build artifacts 112, run acceptance tests, and then release the code to staging & production 110d.

In an example, a developer starts by creating a new/feature branch from the main branch, to work on new features or fixes without directly modifying the main codebase. The developer then makes changes and commits the changes to the feature branch, which involves adding new code, modifying existing code, or deleting unnecessary parts. Once the developer is satisfied with the changes, the developer pushes the feature branch to a remote code repository like GitHub. This makes the feature branch accessible to other developers for review and collaboration.

The developer then creates a PR to trigger a PR pipeline which runs fast quality checks/tests, such as using tools to analyze the code (e.g., static code analysis, linting, security scanning, and the like), unit tests, or the like. Under the existing systems, when any of the checks/tests fail, the PR pipeline run ends and the developer working on the feature branch would have to make the required changes. This does not affect other team member's PRs and CI workflows. For instance, a first feature branch “user/derekp/addNewFeature” can be failing with no impact on a second feature branch “user/bkandoi/addDifferentFeature”, unless the first feature branch is merged into the main branch, at which point the main branch contains the failing test as well. After all checks pass, the PR pipeline runs a PR review. Only when all the checks and the PR review pass, the PR will successfully merge.

To address these technical problems, the technical solution presented herein provides a fast test disablement solution that prevents the above-discussed holds for finding and fixing failed checks/tests by utilizing a disabled test file. In an example, the disabled test file is a yaml file containing a list of tests to suppress and disable for a given code repository. A yaml file, typically ending in .yaml or .yml, is a data serialization language used to store and transmit information in a human-readable format. The yaml file is easy to write and understand (compared to formats like XML), supports various data structures (e.g., lists, dictionaries, and scalar values), has no platform-specific characters, and can represent any valid JSON data. An example yaml file is listed in Table 1. Disabling removes the test entirely, thereby impacting code coverage and hiding potential issues. For example, a test is disabled when the test is known to be broken and needs fixing. Suppressing allows the test to run without affecting the build's success but keeps information about its execution available. For instance, a test is suppressed when the test is unreliable and should not cause build failures.

TABLE 1
DisabledTestCases:
- FullyQualifiedTestCaseName: FooTestWithoutNamespace
- FullyQualifiedTestCaseName: Foo.Test.With.Namespace.TestCase1
SuppressedTestCases:
- FullyQualifiedTestCaseName: BarTestWithoutNamespace
- FullyQualifiedTestCaseName: Bar.Test.With.Namespace.TestCase3

In the existing version control systems, a disabled test Dot file is a test file provided as a part of the build, and it does not efficiently reflect disabled tests into the file. In contrast, the disabled test file of the instant disclosure supports the fast test disablement solution by tracking and synchronizing the disabled tests into the disabled test file in a real-time or substantially real-time manner as a test is disabled. As such, after the disabled test is merged with the main branch, the developer can generate a PR based on the correct version of the disabled test file. As later explained, the fast test disablement solution automatically pulls the disabled test file from the main branch and ensures it has all of the correct versions, such that if a test is disabled in the main branch, a developer does not have to rebuild and requeue a build artifact in order to merge a feature branch into the main branch. Rather, the fast test disablement solution will immediately get the disabled test file to determine a source of truth to suppress and disabled test files, without trying to fix the failing test and then unblock a PR. As a result, the fast test disablement solution saves a lot of time. In this manner, the fast test disablement solution offers bypassing a failed test, so that the rest of the team can move on as usual.

The fast test disablement solution takes the source of truth, skips the failed test(s), and leaves the failed test(s) to another system (e.g., a debt management system) to solve. Later, the failed test(s) is fixed and reenabled. Since the number of failed tests in a lot of project teams and/or organizations is significant, the failed tests can penalize the whole project team. The fast test disablement solution prevents penalizing the developers for failed tests in the system, by allowing PR changes go through, and utilizing another system to fix the failed tests. For example, each failed test that was disabled has a timeline, e.g., 15 days, to be fixed by the test owner. Additionally, in some implementations, mechanisms are used to ensure no regressions go through. Once the disabled test is fixed, the other system (e.g., the debt management system) runs the fixed test again before deploying to production.

This fast test disablement solution supports developers to merge their changes to their target branch without being impacted by other developers' failed/faulty tests in the same project team or other project teams in the organization. If each developer saves a few hours on every PR, multiplying with the number of developers, the last test disablement solution saves a lot of developer hours thus significantly increasing productivity.

A build policy/pipeline (e.g., a build policy 210) runs builds and produces build artifacts, is embedded within a YAML file, and defines rules and restrictions directly within the YAML file. A build policy/pipeline usually controls build triggers (via limiting who can trigger the build, when the build runs, or based on specific conditions), enforces build environment (via specifying allowed agents, resources, and configurations for the build), and defines build quality (via marking builds as passing, failing, or unstable based on specific criteria).

A test policy/pipeline (e.g., a test policy 212) is defined within a YAML file (not specific to build or test tasks), and it defines policies and rules for test execution within a pipeline. A test policy/pipeline usually enforces pass/fail criteria (via setting minimum passing test percentages or specific tests that must pass), controls test execution (via specifying environments, configurations, and data sources for tests), and triggers actions based on test results (via automatically deploying on successful tests or notifying stakeholders on failures). The test policy 212 uses the build produced by the build policy 210 to pick up and run tests. In other words, the tests depend on a build, and re-running tests (usually) does not require obtaining a new build.

A PR is used to propose changes to a codebase by submitting them for review and discussion before merging, and it exists within the version control system. In short, PRs focus on collaboration and code review, while build and test policies/pipelines focus on enforcing quality and security during the build and test phases. PRs are typically user-initiated, while build and test policies/pipelines can be triggered automatically. PRs are specific to code changes, while build and test policies/pipelines can apply to broader aspects of the build and test process. Build policies/pipelines can be triggered by PRs, thereby enforcing build quality before merging. Build policies can trigger test policies, thereby ensuring tests are run after every successful build. Test policies can be triggered by PRs, providing feedback on code quality and functionality before merging.

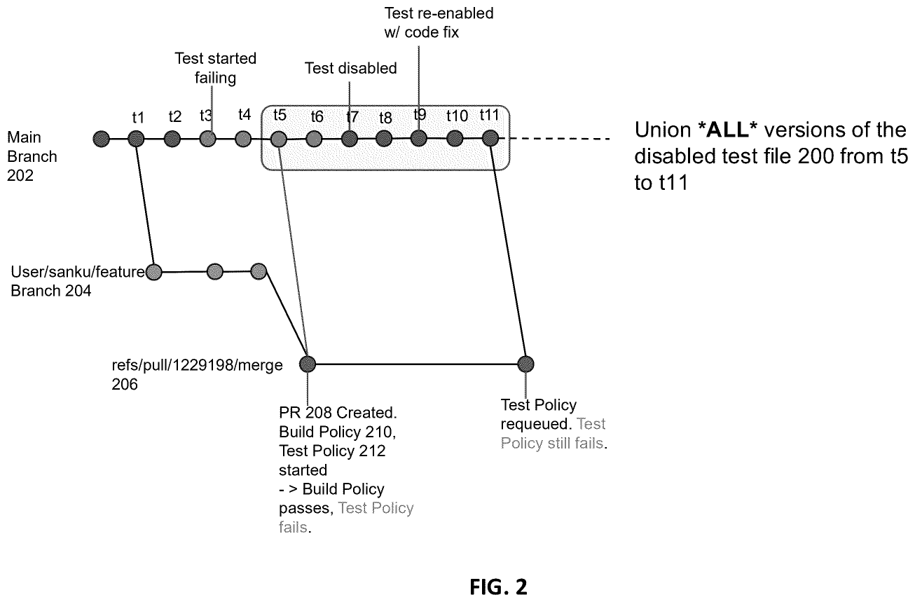

A disabled test file is checked into the code repository 140. The test policy 212 will rely on this file as source of truth for all the tests to disable and suppress. To make the system truly fast, the test policy 212 needs to fetch the latest version of this file, since the file in the build artifacts 112 can be stale. This can be challenging as the latest version of the file will not always be the “Correct” version to apply. The latest version of the disabled test file may not contain all failed test(s) in some scenarios, such as the scenario depicted in FIG. 2.

FIG. 2 is a conceptual diagram of the fast test disablement for pull request and continuous integration workflows of the system of FIGS. 1A-1B. FIG. 2 is a conceptual diagram showing that most of the time a main branch 202 is correct and team members build their own branches off the main branch 202 to develop code on feature branches, and then the team members merge feature branches back to the main branch 202. In FIG. 2, at t1, a developer started a feature branch 204 from the main branch 202. At t3, a test started failing. When the test started failing, it blocked the entire team working on the main branch 202 associated with the code repository. The block goes beyond the main branch 202, and affects everybody who shares the main branch 202, because the main branch 202 is what everyone uses as the source of truth.

The developer of the feature branch 204 might not know about the test that started failing at t3, and wants to merge his or her feature branch 204 to the main branch 202, usually via a pull request. At t5, build artifacts 112 are generated by a separate policy/pipeline referenced as the build policy 210. Meanwhile, a PR 208 is created from the developer's feature branch 204 at t5 to be merged onto the main branch 202. When the test policy 212 is invoked at t5, changes from the feature branch 204 are going to merge with the main branch 202 onto a refs merge 206.

However, when something is wrong with the main branch 202, the test of the PR 208 will start to fail. Tests in a CI system can fail for a variety of reasons, code-related issues (e.g., bugs, regressions, incorrect test logic, or the like) and non-code-related issues (e.g., environment Issues like missing dependencies, network issues, errors in the CI configuration, insufficient resources, external dependencies on databases, APIs, or the like). Now the developer might not be sure whether it is something that he pulled from his or her feature branch 204 or something on the main branch 202 that is failing. In an example, a failing test locating system determines if something is wrong with the main branch 202. According to a first method, the failing test locating system runs a continuous test integration in a new pipeline (such as on another feature branch). If the developer does not see a problem on the new pipeline, the failing test locating system determines that there is an issue with the main branch 202. According to a second method, the failing test locating system analyzes all the PRs in real time and if a test is failing in multiple PRs (e.g., three PRs), the failing test locating system determines that a failing test is not caused by the developer's change, but it is on the main branch 202. This determination may be made because the test is failing in three different pull requests. The failing test locating system can combine these two methods to determine if there is an issue in the main branch 202.

In the existing systems, merging would not occur, and the developer's PR 208 would fail, because the failing test is still in the main branch 202, and the PR 208 used the version of the disabled test file 200 at t5 (when the developer started the PR 208 that contains the test started failing at t3). If the developer wants to fix the failing test, the developer will have to redo everything manually from t3 (via pulling the disabled test file, merging all PRs, running the policies again, etc.) in order to merge the PR 208 again into the main branch 202. This can take hours depending on the code repository size, schedule, and complexity. The fast test disablement solution disclosed herein provide a quick and efficient mechanism to ensure that the correct disabled test file version(s) are put into operation without the need to spend significant time and computing resources on fixing the failing test at this stage of the process.

As mentioned above, the test on the main branch 202 fails at t3, and continues as a failed test which has not been disabled at t5. The build policy 210 and the test policy 212 usually start about the same time. To simplify the discussion, FIG. 2 shows only one failed test and one fix. As a result, the test policy 212 fails at 15, rightfully. After this, in the main branch 202, the failed test is disabled at 17, and then reenabled with a code fix at t9.

At t11, the developer of the PR 208 requeues the test policy 212. Since the developer just fetched the latest version of the disabled test file 200 that still had the failed test enabled, the build artifacts 112 did not have the code fix. As a result, the test policy 212 will still fail at t11. As such, the developer's PR 208 is held up by the failed test on the main branch 202.

To unblock the developer's PR 208, the fast test disablement solution executes the following behind the scenes, without involvement of an on-call engineer or a developer. The fast test disablement solution determines whether the artifact in with build policy 210 is identical with the artifact in the test policy 212.

When the artifact in the build policy is identical with the artifact in the test policy (e.g., the test policy 212), the fast fest disablement solution determines that the failed test did not affect the build artifact and fetches from the code repository a latest version of the disabled test file 200 associated with the target branch, and applies the requeued test policy (e.g., the requeued test policy 212) using the latest version of the disabled test file 200 as a source of truth to disable and suppress tests.

When the artifact in the build policy is not identical with the artifact in the test policy, the fast test disablement solution determines that the failed test affected the build artifact, obtains all versions of the disabled test file 200 in the main branch (can be a release branch in a release branch scenario) between a specified time window t5-t11, and then generates a union of their content. The test policy 212 or a union logic knows the instance timings and calculates the time window. For example, the test policy 212 or the union logic goes to the main branch, retrieves all the edits to the disabled test file, and then merges them as all the tests needed to be disabled in the workflow and in the pull request. In other words, the test policy 212 or the union logic consolidates all the edits to the disabled test file in the branch main 202 from t5->t11 plus what is in the feature branch associated with the PR. All the developers working on this code repository may do something currently. As such, the test policy 212 or the union logic will merge all the edits during the time window and give the result to the PR requesting developer. Although there can be many edits, there may be just one or two failed tests to process as shown in FIG. 2. In this example, such union content includes the test remained failing at t5-t6, disabled at t7, then reenabled at 19 in FIG. 2. In some implementations, instead of requeuing the test policy 212 at t11, the developer can requeue the test policy 212 any time after the test is disabled and tracked in the disabled test file 200, such as at t8, t9, or t10. Since the fast test disablement solution does not concern whether a failed test is fixed, the fast fest disablement solution is not conditioned upon the test re-enablement or its timing, although the test re-enablement can remove the test from the disabled test file 200.

The size of the time window depends on the different applications. The time window is relatively small during the build stage of the software development life cycle. However, the time window becomes large when the build policy and the test policy start together. For example, the time window is set as five hours to rerun the tests and ensure that the tests are reliable. When the policies run the tests while the build is still old, the time window might be 6 hours or one day, depending on the use cases. During the build stage of the software development lifecycle, the time window may be 2-5 hours, but for the test stage of the software development lifecycle, the time window may last longer. Some developers can technically run tests on a build that is as old as several days, so that the time window could also be up to several days. In the system, these time values are configurable.

The test policy 212 will apply this union content as the source of truth to disable and suppress failed tests. Here, t5 is the start time of the build policy that has the artifact being used by the failed test policy 212 (which maps to the start time of the build policy 210, e.g., MainAtTimeOfCBKickOff), and t11 is the start time of the current/requeued test policy 212 (e.g., LatestMain).

In short, in cases where the artifact in the build policy/pipeline is the same as the artifact in the failed test policy 212, the fast test disablement solution automatically takes only the latest version of the disabled test file 200. In cases where the artifact in the build policy/pipeline and the artifact in the failed test policy 212 are different, the fast test disablement solution will take the union content. Table 2 lists the pseudocode of the union logic, independent of specific syntax. The “superset” can hold tests of the disabled test file 200 as well as additional tests.

TABLE 2

```
DownloadTestData
{
  1. Get pull request information ( https://dev.azure.co
m/ {organization}/ {project}/_apis/git/repositories/ {re
positoryId}/pullrequests?api-version=7.1-preview.1)
  2. Determine changes in pull request (https://dev.azur
e.com/onedrive/{ProjectName}/_apis/git/repositories/{rep
oName}/pullRequests/{prID}/iterations?api-version=7.1)
  if (pull request does not have changes to the disabled
  test file)
  {
    3. Get commits from the time of the build start until
  the session runs(https://dev.azure.com/onedrive/{Projec
tName}/_apis/git/repositories/{repository}/commits?searc
hCriteria.itemVersion.version={targetbranchName}&searchC
riteria.itemPath={disabledfilePath}&searchCriteria.fromD
ate={artifactPipeLineStartTime})
    foreach commit
    {
4. Get content of disabled test file(https://dev.azure.c
om/{organization}/{project}/_apis/sourceProviders/{provi
derName}/filecontents?api-version=7.1-preview.1)
      5. Add tests in content to superset of tests to di
sable.
    }
  }
}
```

The fast test disablement solution can be used by an OCE to disable or enable a failed test based on the source of truth. In one embodiment, the OCE disables a failed test by adding the test to the disabled test file 200. Once the PR 208 is checked in the code repository 140, the test is fully disabled, thereby unblocking changes to the target branches (e.g., other PRs).

In another embodiment, the OCE re-enables a failed test by removing the test from the disabled test file 200. Once the PR 208 is checked in the code repository 140 with necessary fix(es), the test is fully enabled, thereby unblocking the PR 208 with the fix(es). In an example, the fast test disablement solution disables/enables the failed test based on build time for other PRs.

In addition, the fast test disablement solution applies the intent of the developer who submitted the PR 208, depending on whether the developer edited the disabled test file 200. In particular, the fast test disablement solution gets pull request information, and determines changes in the PR 208. If the PR 208 does not have change(s) to the disabled test file 200, the fast test disablement solution gets versions/commits of the disabled test file 200 from the time of the build starts until the build session ends.

If the PR 208 has change(s) to the disabled test file 200, the fast test disablement solution obtains content of the disabled test file 200, and adds tests in the union content to suppress and disable the tests. The fast test disablement solution determines the developer's intent for specific changes in the disabled test file 200, and only overrides those changes in the union content or based on a maximum number of versions/commits, whichever is less. In one embodiment, the fast test disablement solution sets a maximum limit on the number of commits to fetch from the code repository 140. The fast test disablement solution includes the oldest version/commit in the window, and then work down from latest version/commit till reaching the maximum number of commits or end of commits, whichever is lesser.

Referring back to the example time window size of 36 hours, there may be a lot of different versions of the disabled test file 200. However, the disabled test file 200 was changed only a few times (e.g., averaged 2-3 times in the 36 hours), so the maximum number of versions of the disabled test file 200 can be set as a single digit (e.g., 7).

For example, the fast test disablement solution can determine the developer's intent for re-enablement through any line deletion in the disabled test file 200 at the start time of the current/requeued test policy 212. The fast test disablement solution assumes a line in deletion ‘DisabledTestCases’ plus modifying some external file in the PR 208 as a valid user intent for test re-enablement/fix. The fast test disablement solution takes the union content with the re-enablement/fix as an override of the disabled test file 200. If the test is still broken, the fast test disablement solution assumes the error is still on the branch. The fast test disablement solution can either fix the test to re-enable the test, or just revert the line deletion in the disabled test file 200 to give up the intent to re-enable the test. If the reenabled test exists in the union content as previously disabled, the re-enablement is accepted as the overwrite in the union content.

The developer's intent solution can be accomplished as discussed above using API Calls of any cloud-based suite of DevOps tools based on the pseudocode in Table 3. Such API provides a way for developers and other tools to interact with any cloud-based suite of DevOps tools programmatically.

TABLE 3

| 1. | Check if the PR has touched the disabled test file (2/3 calls based on if PR touched | |
|---|---|---|
| | file or not) | |
| | a. | Get pull request details and iteration count |
| | | https://dev.azure.com/onedrive/{ProjectName}/_apis/git/repositories/{repoNam |
| | | e }/pullRequests/{prID}/iterations?api-version=7.1 |
| | b. | Get list of file changes in PR between initial commit and latest iteration |
| | | https://dev.azure.com/onedrive/{ProjectName}/_apis/git/repositories/{repoNam |
| | | e}/pullRequests/{prID}/iterations/{iterationNumber}/changes?api-version=7.1 |
| | c. | IF PR has changes to the disabled test file, get the disabled test file content in |
| | | the merged/target branch. CT already has an AZDO API call to fetch this |
| 2. | Generate Union content of versions of the disabled test file from target branch (2+N | |
| | Calls, where N is the total commit for the disabled test file in a given window or | |
| | MAX number of commits to fetch, whichever is less) | |
| | a. | Get artifact policy/pipeline start time. Not sure if CT already has the metadata |
| | | for artifact pipeline. If not, then use one Azdo call to get pipeline details |
| | b. | Get all commits in target branch from artifact start time to current policy start |
| | | time |
| | | https://dev.azure.com/onedrive/{ProjectName}/_apis/git/repositories/{repositor |
| | | y}/commits?searchCriteria.itemVersion.version={targetbranchName}&searchC |
| | | riteria.itemPath={disabledfilePath}&searchCriteria.fromDate={artifactPipeLine |
| | | StartTime} |
| | c. | For each of those commits, get content of disabled test file from target branch |
| | | This call is similar to get 1.c. Gets file content from a given commit id, branch |
| | d. | Build a Set of disabled and suppressed tests to form the union. |

To reenable a test, e.g., Test A which is disabled and listed in the disabled test file 200, the developer has to fix Test A, remove Test A from the disabled test file 200 and run Test A in all the peers. Once the developer removes Test A from the disabled test file 200, Test A will no longer be disabled. An issue in previously used systems is that, as soon as the developer removes Test A from the disabled test file, the existing lodging logic which merges all the branches in that time window will find the previous time window when the test was disabled. When the system does the union of all the branches, even though the developer wants to reenable Test A, because an older branch from an older window had it disabled, the union will still call Test A disabled. As a result, the developer would be unable to reenable Test A.

However, the fast test disablement solution supports a developer reenable Test A by editing the disabled test file 200 in the PR 208. The fast test disablement solution can first apply all the union logic and then check if the developer has reenabled Test A in the branch. If yes, then the fast test disablement solution will remove Test A from the union content of the disabled test file because the developer wants to enable it. As such, Test A should not be in the union content. After assembling the union content, if the developer has changed the disabled test file 200 and removed Test A from the disabled test file 200, the fast test disablement solution just removes Test A from the final union content so the system is protected in all scenarios of running Test A. When the developer did not edit the disabled test file, the fast test disablement solution merely uses the union content to suppress and disable tests. Because the union content is a union of everything till the time window, the union content will also include the developer's file in the feature branch. If the developer adds Test A to the disabled test file 200, which should be outside of the time window and consequentially included in the union content. In a special case when a developer wants to remove Test A only from the PR 208, the fast test disablement solution will query where the developer is removing Test A from, and uses a special logic to assemble the union content. If the developer is removing Test A from the PR 208, the fast test disablement solution gets a list of tests used for getting APIs and then removes Test A from the final union content manually by the special logic. Whenever the developer removes Test A from the disabled test file 200, the developer intended to change the disabled test file 200. In other words, as long as the PR 208 has the disabled test file 200 where Test A is being changed, the fast test disablement solution removes Test A from the union content. The fast test disablement solution always honors a developer's removal of a test form the disabled test file 200.

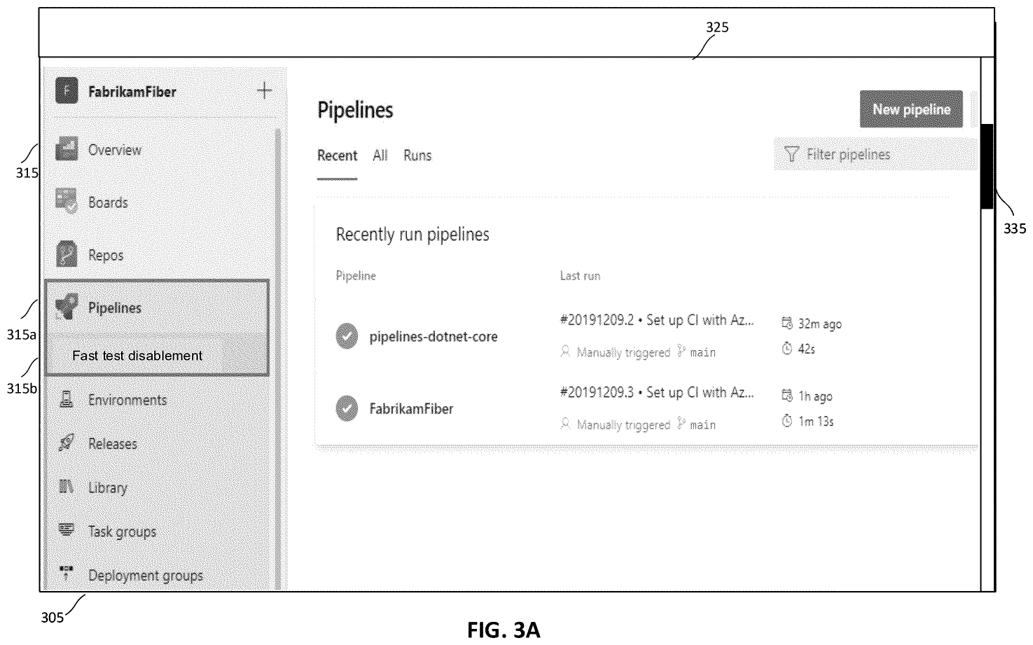

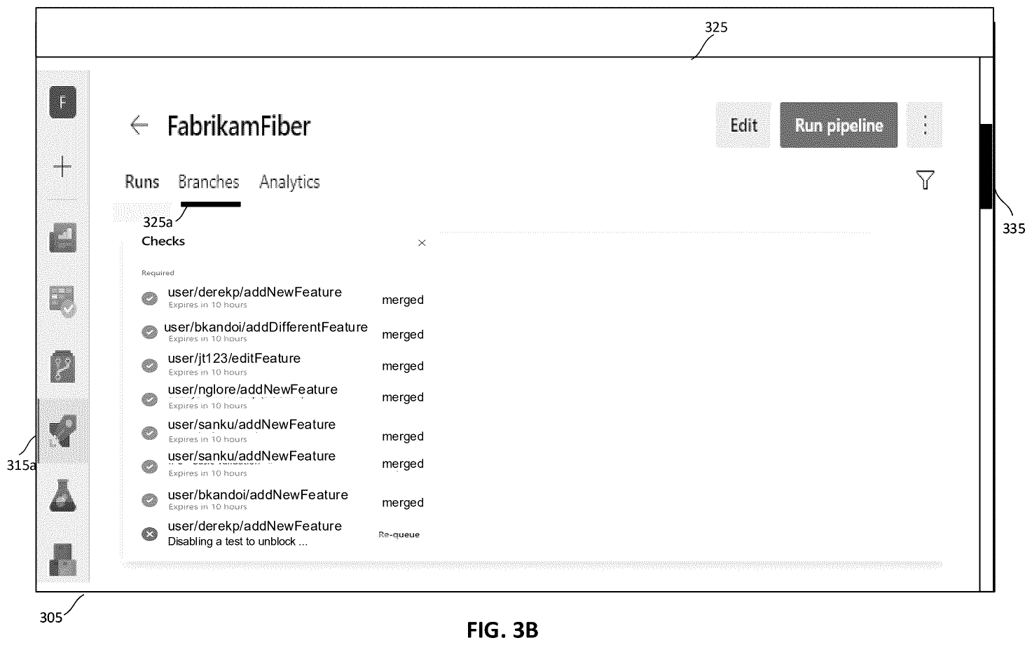

FIG. 3A is a diagram of an example user interface of a fast test disablement solution that implements the techniques described herein. The example user interface shown in FIG. 3A is a user interface of a software development platform. The techniques herein for providing fast test disablement for pull request and continuous integration workflows may be used in any software development platform for developing any types of applications including but not limited to presentation applications, website authoring applications, collaboration platforms, communications platforms, and/or other types of applications. Such a fast test disablement solution can be a stand-alone application, or a plug-in of any application on a server, a cloud, or even a client device.

FIG. 3A shows an example user interface 305 of the software development platform in which the user is interacting with the software development platform to view and manage pipelines. The user interface 305 includes a control pane 315, a content pane 325 and a scrollbar 335. The user interface 305 may be implemented by a native application and/or a browser application.

In some implementations, the control pane 315 includes an Overview tab/button, a Board tab/button, a Repos tab/button, a Pipelines tab/button 315a, a Fast Test Disablement tab/button 315b, an Environment tab/button, a Releases tab/button, a Library tab/button, a Task Group tab/button, a Development Group tab/button, or the like. A developer can build an application from a Git repository, and view/manage pipelines by choosing the “Pipelines” tab/button 315a from the control pane 315 to go to the pipelines landing page. From the pipelines landing page, the developer can create and import pipelines, manage security, and drill down into pipeline and run details. In addition, the developer can activate the fast test disablement solution by choosing the Fast Test Disablement tab/button 315b from the control pane 315.

The developer can select a build ID for a run of interest to view the results of that build, select a branch name to view the branch for that run, or select the context menu to run the pipeline and perform other management actions. In FIG. 3B, the content pane 325 includes a Runs tab/button, a Branches tab/button 325a, and an Analytic tab/button. The developer can select the Branches tab/button 325a to check the process of the branches on the pipeline. The content pane 325 shows eight branches with seven branches successfully merged, and one branch failed. A status notification of “Disabling a test to unblock . . . ” is shown under the failed branch, while the fast test disablement solution is working behind the scene so the user can requeue the failed branch. When the developer tried to fix a disabled test in a failed branch by editing the disabled test file 200 (e.g., removing the developer's own test to enable it in the PR 208), this test must run in the PR 208 to be able to test the fix.

The fast test disablement solution can be applied to CI pipelines similarly. A merger of a PR to the code repository 140 triggers a CI pipeline. The CI pipeline runs the same checks/tests as the PR pipeline with some additions, such as integration tests. The fast test disablement solution can be applied to the same checks/tests. Under the existing systems, when any of the checks fail, the CI pipeline ends and the developer would have to make the required changes. By applying the fast test disablement solution, the CI pipeline can bypass failed tests as discussed above.

The fast test disablement solution can scale and protect against potential cloud-based suite of DevOps tool outages and a throttling limit. For example, if such cloud-based suite of DevOps tool is approaching an outage or the fast test disablement solution is throttled, the fast test disablement solution falls back to using the content of the disabled test file 200 in the merged branch. However, if the cloud-based suite of DevOps tools or GIT is experiencing an outage, the system will not be able to run the build or to build the test.

In another scenario, a developer wants to manually change the disabled test file 200, to disable the test. When this occurs once every few days just for that PR of the developer, the fast test disablement solution does not apply the special merging logic and just trust/use the developer's PR. In other words, the fast test disablement solution just takes the disabled test file 200 and the developer's PR, without merging the PR, and the PR treats the edited disabled test file 200 as the source of truth.

Referring back to FIG. 1A, the data factory 120 can be a platform or service that automates the process of ingesting, transforming, and moving data between different sources and destinations. In some implementations, the data factory 120 can extract data from various sources like databases. APIs, or files, transform data by cleaning, filtering, or enriching, and load data into target systems like data warehouses, data lakes, or analytics platforms.

The data sourcing system 125 includes the entire infrastructure and processes involved in acquiring and managing data used by software development. It encompasses various components and functionalities, ensuring the availability, reliability, and quality of data for development and deployment.

In some examples, code developer devices, e.g., developer devices 130, are devices that may be used by code developers to develop code. The code developer device may execute a developer environment and communicate with one or more of the code repositories 140 in order to facilitate the development of code. A code developer may access, review, and/or edit code on a developer environment executing on a code developer device (e.g., a code developer device 130a).

In some implementations, repositories, e.g., code repositories 140, includes source code repositories where developers store and manage their code (e.g., GitHub, Bitbucket, GitLab, or the like), and software package repositories where pre-built software packages are stored and distributed (e.g., Debian packages, npm, Maven Repository, or the like). A source code repository provides version control and a platform for a collaborative team project. A developer uses a source code repository when working on a software project, while using a software package repository when installing pre-built software.

When a code developer, via a code developer device, views a portion of code using the developer environment, the developer environment may provide the code developer with contextualization information that is associated with the code, where the contextualization information may include people and/or documents relevant to the portion of the code that is being viewed.

Network 115 may include one or more computer networks, including wired and/or wireless networks, where each network may be, for example, a wireless network, local area network (LAN), a wide-area network (WAN), and/or a global network such as the Internet. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, and/or other communications links known to those skilled in the art. Furthermore, remote computers and other related electronic devices could be remotely connected to either LANs or WANs via a modem and temporary telephone link. Network 115 may include various other networks such as one or more networks using local network protocols such as 6LoWPAN, ZigBee, or the like. In essence, network 115 may include any suitable network-based communication method by which information may travel among the developer devices 130, the code repositories 140, the data factory 120, the data sourcing system 125, the software development system 105, and the CI/CD workflows 110. Although each device is shown connected as connected to network 115, that does not necessarily mean that each device communicates with each other device shown. In some examples, some devices shown only communicate with some other devices/services shown via one or more intermediary devices. Also, although network 115 is illustrated as one network, in some examples, network 115 may instead include multiple networks that may or may not be connected with each other, with some of the devices shown communicating with each other through one network of the multiple networks and other of the devices shown instead communicating with each other with a different network of the multiple networks.

The application services platform 100 may include more or less devices than illustrated in FIG. 1A, which is shown by way of example only. In one embodiment, the application services platform 100 is independently implemented on one or more developer devices 130. In another embodiment, the developer device 130 and the application services platform 100 communicate with each other over a network (not shown) to implement the system. The network may be a combination of one or more public and/or private networks and may be implemented at least in part by the Internet.

The developer device 130 is a computing device that may be implemented as a portable electronic device, such as a mobile phone, a tablet computer, a laptop computer, a portable digital assistant device, a portable game console, and/or other such devices in some implementations. The developer device 130 may also be implemented in computing devices having other form factors, such as a desktop computer, vehicle onboard computing system, a kiosk, a point-of-sale system, a video game console, and/or other types of computing devices in other implementations. While the example implementation illustrated in FIG. 1A includes a plurality of developer devices 130, other implementations may include a different number of developer devices that utilize services provided by the application services platform 100.

The developer device 130 includes a native application and a browser application. The native application is a web-enabled native application, in some implementations, which enables users to view, create, and/or modify tests/branches/pipelines as supported by the fast test disablement for pull request and continuous integration workflows. The web-enabled native application utilizes services provided by the application services platform 100 including but not limited to creating, viewing, and/or modifying various types of tests/branches/pipelines as supported by the fast test disablement for pull request and continuous integration workflows. The native application implements the fast test disablement for pull request and continuous integration workflows of the system as shown in FIG. 1B in some implementations. In other implementations, the browser application is used for accessing and viewing web-based tests/branches/pipelines provided by the application services platform 100. In such implementations, the application services platform 100 implements one or more web applications, such as the browser application, which enables users to view, create, and/or modify tests/branches/pipelines as supported by the fast test disablement for pull request and continuous integration workflows. The browser application implements the user interface 305 shown in FIGS. 3A-3B in some implementations. The application services platform 100 supports both the native application and the browser application in some implementations, and the users may choose which tests/branches/pipelines best suits their needs.

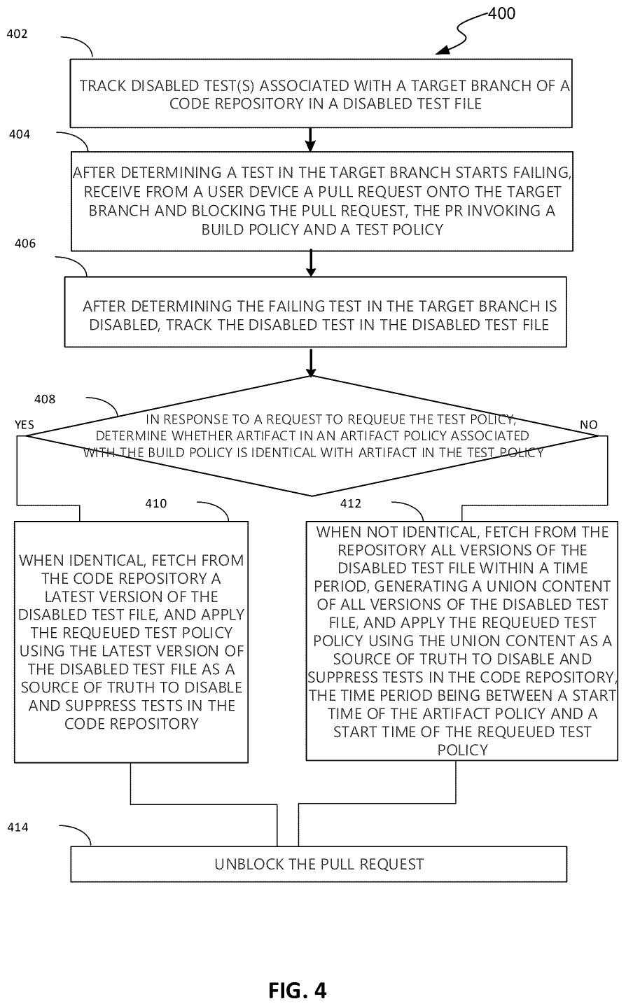

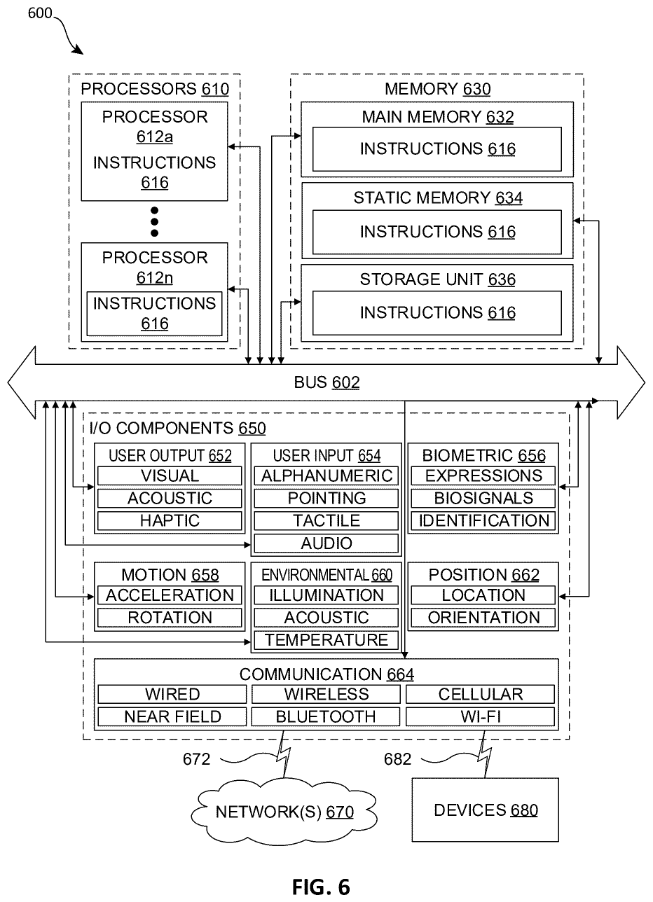

FIG. 4 is a flow chart of an example process 400 for providing fast test disablement for pull request and continuous integration workflows according to the techniques disclosed herein. The process 400 can be implemented by the application services platform 100 or its components shown in the preceding examples. The process 400 may be implemented in, for instance, the example machine including a processor and a memory as shown in FIG. 6. As such, the application services platform 100 can provide means for accomplishing various parts of the process 400, as well as means for accomplishing embodiments of other processes described herein in conjunction with other components of the application services platform 100. Although the process 400 is illustrated and described as a sequence of steps, it is contemplated that various embodiments of the process 400 may be performed in any order or combination and need not include all the illustrated steps.

In one embodiment, for example, in step 402, a data processing unit of the CI/CD workflows 110 tracks one or more disabled tests associated with a target branch (e.g., the main branch 202 in FIG. 2) of a code repository in a disabled test file 200. For example, the disabled test file 200 is a yaml file, and the target branch is a main branch, a feature branch, or a release branch. In one embodiment, the one or more disabled tests associated with the target branch are tracked in a real-time or substantially real-time manner.

After determining that a test in the target branch starts failing (e.g., at t3 in FIG. 2), in step 404, the data processing unit of the CI/CD workflows 110 receives from a user device (e.g., a developer's device 130a) a pull request to the target branch and blocks the pull request (due to the failing test), while the pull request invokes a build policy (e.g., the build policy 210 in FIG. 2) and a test policy (e.g., the test policy 212 in FIG. 2). In an example, a user associated with the user device is a developer.

After determining that the failing test in the target branch is disabled, in step 406, the data processing unit of the CI/CD workflows 110 tracks the disabled test in the disabled test file (e.g., at 17 in FIG. 2). In one embodiment, the data processing unit reenables the disabled failed test in the target branch with a code fix (e.g., at 19 in FIG. 2), before requiring the test policy (e.g., requeuing the test policy 212 at t11 in FIG. 2).

In response to a request from the user device (e.g., the developer device 130a) to requeue the test policy after the disabled test is tracked in the disabled test file (e.g., at t7 in FIG. 2), in step 408, the data processing unit of the CI/CD workflows 110 determines whether artifact in the build policy (e.g., the build policy 210 in FIG. 2) is identical with artifact in the test policy (e.g., the test policy 212 in FIG. 2). When it is determined that the artifact in the build policy is identical with the artifact in the test policy in step 410, the data processing unit fetches from a code repository (e.g., a code repository 140a) a latest version of the disabled test file 200, and applies the requeued test policy (e.g., the test policy 212 requeued at t11 in FIG. 2) using the latest version of the disabled test file 200 as a source of truth to disable and suppress tests in the code repository. When it is determined that the artifact in the build policy is not identical with the artifact in the test policy in step 412, the data processing unit fetches from the code repository (e.g., the code repository 140a) all versions of the disabled test file 200 within a time period (e.g., t5-t11 in FIG. 2), generates a union content of all versions of the disabled test file 200, and applies the requeued test policy using the union content as a source of truth to disable and suppress tests in the code repository, the time period being between a start time of the build policy (e.g., at t5 in FIG. 2) and a start time of the requeued test policy (e.g., at t11 in FIG. 2).

In some implementations, the data processing unit determines whether the pull request (e.g., the PR 208 in FIG. 2) includes at least one edit to the disabled test file 200, and (1) when it is determined that the pull request includes no edit to the disabled test file 200, the data processing unit takes no action; or (2) when it is determined that the pull request includes at least one edit (e.g., enabling Test A as discussed) to the disabled test file 200, the data processing unit overwrites the at least one edit into the union content, before using the union content as a source of truth to disable and suppress tests in the code repository. In other implementations, the data processing unit sets a maximum number of versions (e.g., seven) of the disabled test file 200 associated with the target branch (e.g., the main branch 202 in FIG. 2) within the time period (e.g., t5-t11 in FIG. 2) to fetch for generating the union content; and fetches based on ages of the versions of the disabled test file 200 within the time period from the oldest version until reaching the maximum number. In these cases, the union content is generated based on the fetched versions of the disabled test file 200, when the maximum number is lower than a number of all versions of the disabled test file 200.

In step 414, the data processing unit of the CI/CD workflows 110 unblocks the pull request. As a result, the developer and other developers in the project teams continue the CI workflow(s). As mentioned, the fast test disablement solution skips failed test(s) and leaves the failed tests to be fixed by another system later.

In one embodiment, when determining that there is a version control outage or throttle, the data processing unit of the CI/CD workflows 110 uses content of the disabled test file 200 as a source of truth to disable and suppress tests in the code repository.

All the above-discussed tests/branches/pipelines can be stored in the code repositories 140 of an enterprise data storage. The enterprise data storage can be physical and/or virtual, depending on the entity's needs and IT infrastructure. Examples of physical enterprise data storage systems include network-attached storage (NAS), storage area network (SAN), direct-attached storage (DAS), tape libraries, hybrid storage arrays, object storage, and the like. Examples of virtual enterprise data storage systems include virtual SAN (vSAN), software-defined storage (SDS), cloud storage, hyper-converged Infrastructure (HCl), network virtualization and software-defined networking (SDN), container storage, and the like.

In an example, the application services platform 100 can store enterprise data separately from software development data, to reduce the risk of unintentionally leaking sensitive information. The application services platform 100 can limit access to the software development data and the enterprise data. The application services platform 100 can also implement proper access controls, strong authentication, and authorization mechanisms to ensure that only authorized personnel can interact with the software development data and the enterprise data.

The application services platform 100 can also run the fast fest disablement solution in a secure computing environment. Moreover, the application services platform 100 can employ robust network security, firewalls, and intrusion detection systems to protect against external threats. The application services platform 100 can encrypt the enterprise data and any data in transit. The application services platform 100 can also employ encryption standards for data storage and data transmission to safeguard against data breaches.

Moreover, the application services platform 100 can implement strong security measures around the fast test disablement solution itself, such as regular security audits, code reviews, and ensuring that the disabled test file 200 is up-to-date. The application services platform 100 can periodically audit the fast test disablement solution's usage and access logs, to detect any unauthorized or anomalous activities. The application services platform 100 can also ensure that any use of the fast test disablement solution complies with relevant data protection regulations such as GDPR, HIPAA, or other industry-specific compliance standards.

The detailed examples of systems, devices, and techniques described in connection with FIGS. 1-4 are presented herein for illustration of the disclosure and its benefits. Such examples of use should not be construed to be limitations on the logical process embodiments of the disclosure, nor should variations of user interface methods from those described herein be considered outside the scope of the present disclosure. It is understood that references to displaying or presenting an item (such as, but not limited to, presenting an image on a display device, presenting audio via one or more loudspeakers, and/or vibrating a device) include issuing instructions, commands, and/or signals causing, or reasonably expected to cause, a device or system to display or present the item. In some embodiments, various features described in FIGS. 1-4 are implemented in respective modules, which may also be referred to as, and/or include, logic, components, units, and/or mechanisms. Modules may constitute either software modules (for example, code embodied on a machine-readable medium) or hardware modules.

In some examples, a hardware module may be implemented mechanically, electronically, or with any suitable combination thereof. For example, a hardware module may include dedicated circuitry or logic that is configured to perform certain operations. For example, a hardware module may include a special-purpose processor, such as a field-programmable gate array (FPGA) or an Application Specific Integrated Circuit (ASIC). A hardware module may also include programmable logic or circuitry that is temporarily configured by software to perform certain operations and may include a portion of machine-readable medium data and/or instructions for such configuration. For example, a hardware module may include software encompassed within a programmable processor configured to execute a set of software instructions. It will be appreciated that the decision to implement a hardware module mechanically, in dedicated and permanently configured circuitry, or in temporarily configured circuitry (for example, configured by software) may be driven by cost, time, support, and engineering considerations.

Accordingly, the phrase “hardware module” should be understood to encompass a tangible entity capable of performing certain operations and may be configured or arranged in a certain physical manner, be that an entity that is physically constructed, permanently configured (for example, hardwired), and/or temporarily configured (for example, programmed) to operate in a certain manner or to perform certain operations described herein. As used herein, “hardware-implemented module” refers to a hardware module. Considering examples in which hardware modules are temporarily configured (for example, programmed), each of the hardware modules need not be configured or instantiated at any one instance in time. For example, where a hardware module includes a programmable processor configured by software to become a special-purpose processor, the programmable processor may be configured as respectively different special-purpose processors (for example, including different hardware modules) at different times. Software may accordingly configure a processor or processors, for example, to constitute a particular hardware module at one instance of time and to constitute a different hardware module at a different instance of time. A hardware module implemented using one or more processors may be referred to as being “processor implemented” or “computer implemented.”

Hardware modules can provide information to, and receive information from, other hardware modules. Accordingly, the described hardware modules may be regarded as being communicatively coupled. Where multiple hardware modules exist contemporaneously, communications may be achieved through signal transmission (for example, over appropriate circuits and buses) between or among two or more of the hardware modules. In embodiments in which multiple hardware modules are configured or instantiated at different times, communications between such hardware modules may be achieved, for example, through the storage and retrieval of information in memory devices to which the multiple hardware modules have access. For example, one hardware module may perform an operation and store the output in a memory device, and another hardware module may then access the memory device to retrieve and process the stored output.

In some examples, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by, and/or among, multiple computers (as examples of machines including processors), with these operations being accessible via a network (for example, the Internet) and/or via one or more software interfaces (for example, an application program interface (API)). The performance of certain of the operations may be distributed among the processors, not only residing within a single machine, but deployed across several machines. Processors or processor-implemented modules may be in a single geographic location (for example, within a home or office environment, or a server farm), or may be distributed across multiple geographic locations.

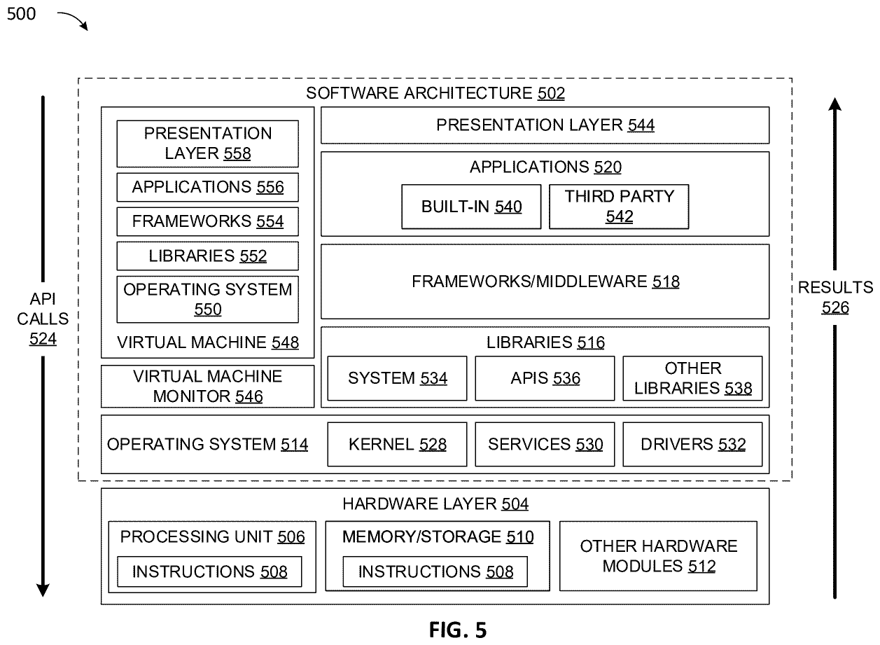

FIG. 5 is a block diagram 500 illustrating an example software architecture 502, various portions of which may be used in conjunction with various hardware architectures herein described, which may implement any of the above-described features. FIG. 5 is a non-limiting example of a software architecture, and it will be appreciated that many other architectures may be implemented to facilitate the functionality described herein. The software architecture 502 may execute on hardware such as a machine 600 of FIG. 6 that includes, among other things, processors 610, memory 630, and input/output (I/O) components 650. A representative hardware layer 504 is illustrated and can represent, for example, the machine 600 of FIG. 6. The representative hardware layer 504 includes a processing unit 506 and associated executable instructions 508. The executable instructions 508 represent executable instructions of the software architecture 502, including implementation of the methods, modules and so forth described herein. The hardware layer 504 also includes a memory/storage 510, which also includes the executable instructions 508 and accompanying data. The hardware layer 504 may also include other hardware modules 512. Instructions 508 held by processing unit 506 may be portions of instructions 508 held by the memory/storage 510.

The example software architecture 502 may be conceptualized as layers, each providing various functionality. For example, the software architecture 502 may include layers and components such as an operating system (OS) 514, libraries 516, frameworks 518, applications 520, and a presentation layer 544. Operationally, the applications 520 and/or other components within the layers may invoke API calls 524 to other layers and receive corresponding results 526. The layers illustrated are representative in nature and other software architectures may include additional or different layers. For example, some mobile or special purpose operating systems may not provide the frameworks/middleware 518.

The OS 514 may manage hardware resources and provide common services. The OS 514 may include, for example, a kernel 528, services 530, and drivers 532. The kernel 528 may act as an abstraction layer between the hardware layer 504 and other software layers. For example, the kernel 528 may be responsible for memory management, processor management (for example, scheduling), component management, networking, security settings, and so on. The services 530 may provide other common services for the other software layers. The drivers 532 may be responsible for controlling or interfacing with the underlying hardware layer 504. For instance, the drivers 532 may include display drivers, camera drivers, memory/storage drivers, peripheral device drivers (for example, via Universal Serial Bus (USB)), network and/or wireless communication drivers, audio drivers, and so forth depending on the hardware and/or software configuration.

The libraries 516 may provide a common infrastructure that may be used by the applications 520 and/or other components and/or layers. The libraries 516 typically provide functionality for use by other software modules to perform tasks, rather than interacting directly with the OS 514. The libraries 516 may include system libraries 534 (for example, C standard library) that may provide functions such as memory allocation, string manipulation, file operations. In addition, the libraries 516 may include API libraries 536 such as media libraries (for example, supporting presentation and manipulation of image, sound, and/or video data formats), graphics libraries (for example, an OpenGL library for rendering 2D and 3D graphics on a display), database libraries (for example, SQLite or other relational database functions), and web libraries (for example, WebKit that may provide web browsing functionality). The libraries 516 may also include a wide variety of other libraries 538 to provide many functions for applications 520 and other software modules.

The frameworks 518 (also sometimes referred to as middleware) provide a higher-level common infrastructure that may be used by the applications 520 and/or other software modules. For example, the frameworks 518 may provide various graphic user interface (GUI) functions, high-level resource management, or high-level location services. The frameworks 518 may provide a broad spectrum of other APIs for applications 520 and/or other software modules.

The applications 520 include built-in applications 540 and/or third-party applications 542. Examples of built-in applications 540 may include, but are not limited to, a contacts application, a browser application, a location application, a media application, a messaging application, and/or a game application. Third-party applications 542 may include any applications developed by an entity other than the vendor of the particular platform. The applications 520 may use functions available via OS 514, libraries 516, frameworks 518, and presentation layer 544 to create user interfaces to interact with users.

Some software architectures use virtual machines, as illustrated by a virtual machine 548. The virtual machine 548 provides an execution environment where applications/modules can execute as if they were executing on a hardware machine (such as the machine 600 of FIG. 6, for example). The virtual machine 548 may be hosted by a host OS (for example, OS 514) or hypervisor, and may have a virtual machine monitor 546 which manages operation of the virtual machine 548 and interoperation with the host operating system. A software architecture, which may be different from software architecture 502 outside of the virtual machine, executes within the virtual machine 548 such as an OS 550, libraries 552, frameworks 554, applications 556, and/or a presentation layer 558.

FIG. 6 is a block diagram illustrating components of an example machine 600 configured to read instructions from a machine-readable medium (for example, a machine-readable storage medium) and perform any of the features described herein. The example machine 600 is in a form of a computer system, within which instructions 616 (for example, in the form of software components) for causing the machine 600 to perform any of the features described herein may be executed. As such, the instructions 616 may be used to implement modules or components described herein. The instructions 616 cause unprogrammed and/or unconfigured machine 600 to operate as a particular machine configured to carry out the described features. The machine 600 may be configured to operate as a standalone device or may be coupled (for example, networked) to other machines. In a networked deployment, the machine 600 may operate in the capacity of a server machine or a client machine in a server-client network environment, or as a node in a peer-to-peer or distributed network environment. Machine 600 may be embodied as, for example, a server computer, a client computer, a personal computer (PC), a tablet computer, a laptop computer, a netbook, a set-top box (STB), a gaming and/or entertainment system, a smart phone, a mobile device, a wearable device (for example, a smart watch), and an Internet of Things (IoT) device. Further, although only a single machine 600 is illustrated, the term “machine” includes a collection of machines that individually or jointly execute the instructions 616.

The machine 600 may include processors 610, memory 630, and I/O components 650, which may be communicatively coupled via, for example, a bus 602. The bus 602 may include multiple buses coupling various elements of machine 600 via various bus technologies and protocols. In an example, the processors 610 (including, for example, a central processing unit (CPU), a graphics processing unit (GPU), a digital signal processor (DSP), an ASIC, or a suitable combination thereof) may include one or more processors 612a to 612n that may execute the instructions 616 and process data. In some examples, one or more processors 610 may execute instructions provided or identified by one or more other processors 610. The term “processor” includes a multi-core processor including cores that may execute instructions contemporaneously. Although FIG. 6 shows multiple processors, the machine 600 may include a single processor with a single core, a single processor with multiple cores (for example, a multi-core processor), multiple processors each with a single core, multiple processors each with multiple cores, or any combination thereof. In some examples, the machine 600 may include multiple processors distributed among multiple machines.

The memory/storage 630 may include a main memory 632, a static memory 634, or other memory, and a storage unit 636, both accessible to the processors 610 such as via the bus 602. The storage unit 636 and memory 632, 634 store instructions 616 embodying any one or more of the functions described herein. The memory/storage 630 may also store temporary, intermediate, and/or long-term data for processors 610. The instructions 616 may also reside, completely or partially, within the memory 632, 634, within the storage unit 636, within at least one of the processors 610 (for example, within a command buffer or cache memory), within memory at least one of I/O components 650, or any suitable combination thereof, during execution thereof. Accordingly, the memory 632, 634, the storage unit 636, memory in processors 610, and memory in I/O components 650 are examples of machine-readable media.

As used herein, “machine-readable medium” refers to a device able to temporarily or permanently store instructions and data that cause machine 600 to operate in a specific fashion, and may include, but is not limited to, random-access memory (RAM), read-only memory (ROM), buffer memory, flash memory, optical storage media, magnetic storage media and devices, cache memory, network-accessible or cloud storage, other types of storage and/or any suitable combination thereof. The term “machine-readable medium” applies to a single medium, or combination of multiple media, used to store instructions (for example, instructions 616) for execution by a machine 600 such that the instructions, when executed by one or more processors 610 of the machine 600, cause the machine 600 to perform and one or more of the features described herein. Accordingly, a “machine-readable medium” may refer to a single storage device, as well as “cloud-based” storage systems or storage networks that include multiple storage apparatus or devices. The term “machine-readable medium” excludes signals per se.

The I/O components 650 may include a wide variety of hardware components adapted to receive input, provide output, produce output, transmit information, exchange information, capture measurements, and so on. The specific I/O components 650 included in a particular machine will depend on the type and/or function of the machine. For example, mobile devices such as mobile phones may include a touch input device, whereas a headless server or IoT device may not include such a touch input device. The particular examples of I/O components illustrated in FIG. 6 are in no way limiting, and other types of components may be included in machine 600. The grouping of I/O components 650 are merely for simplifying this discussion, and the grouping is in no way limiting. In various examples, the I/O components 650 may include user output components 652 and user input components 654. User output components 652 may include, for example, display components for displaying information (for example, a liquid crystal display (LCD) or a projector), acoustic components (for example, speakers), haptic components (for example, a vibratory motor or force-feedback device), and/or other signal generators. User input components 654 may include, for example, alphanumeric input components (for example, a keyboard or a touch screen), pointing components (for example, a mouse device, a touchpad, or another pointing instrument), and/or tactile input components (for example, a physical button or a touch screen that provides location and/or force of touches or touch gestures) configured for receiving various user inputs, such as user commands and/or selections.

In some examples, the I/O components 650 may include biometric components 656, motion components 658, environmental components 660, and/or position components 662, among a wide array of other physical sensor components. The biometric components 656 may include, for example, components to detect body expressions (for example, facial expressions, vocal expressions, hand or body gestures, or eye tracking), measure biosignals (for example, heart rate or brain waves), and identify a person (for example, via voice-, retina-, fingerprint-, and/or facial-based identification). The motion components 658 may include, for example, acceleration sensors (for example, an accelerometer) and rotation sensors (for example, a gyroscope). The environmental components 660 may include, for example, illumination sensors, temperature sensors, humidity sensors, pressure sensors (for example, a barometer), acoustic sensors (for example, a microphone used to detect ambient noise), proximity sensors (for example, infrared sensing of nearby objects), and/or other components that may provide indications, measurements, or signals corresponding to a surrounding physical environment. The position components 662 may include, for example, location sensors (for example, a Global Position System (GPS) receiver), altitude sensors (for example, an air pressure sensor from which altitude may be derived), and/or orientation sensors (for example, magnetometers).

The I/O components 650 may include communication components 664, implementing a wide variety of technologies operable to couple the machine 600 to network(s) 670 and/or device(s) 680 via respective communicative couplings 672 and 682. The communication components 664 may include one or more network interface components or other suitable devices to interface with the network(s) 670. The communication components 664 may include, for example, components adapted to provide wired communication, wireless communication, cellular communication, Near Field Communication (NFC), Bluetooth communication, Wi-Fi, and/or communication via other modalities. The device(s) 680 may include other machines or various peripheral devices (for example, coupled via USB).

In some examples, the communication components 664 may detect identifiers or include components adapted to detect identifiers. For example, the communication components 664 may include Radio Frequency Identification (RFID) tag readers, NFC detectors, optical sensors (for example, one- or multi-dimensional bar codes, or other optical codes), and/or acoustic detectors (for example, microphones to identify tagged audio signals). In some examples, location information may be determined based on information from the communication components 664, such as, but not limited to, geo-location via Internet Protocol (IP) address, location via Wi-Fi, cellular, NFC, Bluetooth, or other wireless station identification and/or signal triangulation.

In the preceding detailed description, numerous specific details are set forth by way of examples in order to provide a thorough understanding of the relevant teachings. However, it should be apparent that the present teachings may be practiced without such details. In other instances, well known methods, procedures, components, and/or circuitry have been described at a relatively high-level, without detail, in order to avoid unnecessarily obscuring aspects of the present teachings.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element. Furthermore, subsequent limitations referring back to “said element” or “the element” performing certain functions signifies that “said element” or “the element” alone or in combination with additional identical elements in the process, method, article, or apparatus are capable of performing all of the recited functions.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed is:

1. A data processing system comprising:
a processor, and
a machine-readable storage medium storing executable instructions which, when executed by the processor, cause the processor alone or in combination with other processors to perform the following operations:
tracking one or more disabled tests associated with a target branch of a code repository in a disabled test file;
after determining that a test in the target branch has started failing, receiving from a user device a pull request onto the target branch and blocking the pull request, the pull request invoking a build policy and a test policy;
after determining that the failing test in the target branch is disabled, tracking the disabled test in the disabled test file;
in response to a request from the user device to requeue the test policy received after the disabled test is tracked in the disabled test file, determining whether artifact in the build policy is identical with artifact in the test policy;
when it is determined that the artifact in the build policy is identical with the artifact in the test policy, fetching from the code repository a latest version of the disabled test file, and applying the requeued test policy using the latest version of the disabled test file as a source of truth to disable and suppress tests in the code repository; or
when it is determined that the artifact in the build policy is not identical with the artifact in the test policy, fetching from the code repository all versions of the disabled test file within a time period, generating a union content of all versions of the disabled test file, and applying the requeued test policy using the union content as a source of truth to disable and suppress tests in the code repository, the time period being between a start time of the build policy and a start time of the requeued test policy; and
unblocking the pull request.

2. The data processing system of claim 1, wherein the machine-readable storage medium further includes instructions configured to cause the processor alone or in combination with other processors to perform operations of:
reenabling the disabled test in the target branch with a code fix, before requeuing the test policy.

3. The data processing system of claim 2, wherein the machine-readable storage medium further includes instructions configured to cause the processor alone or in combination with other processors to perform operations of:
determining whether the pull request includes at least one edit to the disabled test file, and
(1) when it is determined that the pull request includes no edit to the disabled test file, taking no action; or
(2) when it is determined that the pull request includes at least one edit to the disabled test file, overwriting the at least one edit into the union content, before using the union content as a source of truth to disable and suppress tests in the code repository.

4. The data processing system of claim 3, wherein the machine-readable storage medium further includes instructions configured to cause the processor alone or in combination with other processors to perform operations of:
setting a maximum number of versions of the disabled test file associated with the target branch within the time period to fetch for generating the union content; and
fetching based on ages of the versions of the disabled test file within the time period from the oldest version until reaching the maximum number,
wherein the union content is generated based on the fetched versions of the disabled test file, when the maximum number is lower than a number of all versions of the disabled test file.

5. The data processing system of claim 1, wherein the machine-readable storage medium further includes instructions configured to cause the processor alone or in combination with other processors to perform operations of:
when determining that there is a version control outage or throttle, using content of the disabled test file as a source of truth to disable and suppress tests in the code repository.

6. The data processing system of claim 1, wherein the one or more disabled tests associated with the target branch are tracked in a real-time or substantially real-time manner.

7. The data processing system of claim 1, wherein the target branch is a main branch, a feature branch, or a release branch.

8. The data processing system of claim 1, wherein the disabled test file is a yaml file, and wherein a user associated with the user device is a developer.

9. A computer-implemented method comprising:
tracking one or more disabled tests associated with a target branch of a code repository in a disabled test file;
after determining that a test in the target branch starts failing, receiving from a user device a pull request onto the target branch and blocking the pull request, the pull request invoking a build policy and a test policy;
after determining that the failing test in the target branch is disabled, tracking the disabled test in the disabled test file;
in response to a request from the user device to requeue the test policy received after the disabled test is tracked in the disabled test file, determining whether artifact in the build policy is identical with artifact in the test policy;
when it is determined that the artifact in the build policy is identical with the artifact in the test policy, fetching from the code repository a latest version of the disabled test file, and applying the requeued test policy using the latest version of the disabled test file as a source of truth to disable and suppress tests in the code repository; or
when it is determined that the artifact in the build policy is not identical with the artifact in the test policy, fetching from the code repository all versions of the disabled test file within a time period, generating a union content of all versions of the disabled test file, and applying the requeued test policy using the union content as a source of truth to disable and suppress tests in the code repository, the time period being between a start time of the build policy and a start time of the requeued test policy; and
unblocking the pull request.

10. The method of claim 9, further comprising:
reenabling the disabled test in the target branch with a code fix, before requeuing the test policy.

11. The method of claim 10, further comprising:
determining whether the pull request includes at least one edit to the disabled test file, and
(1) when it is determined that the pull request includes no edit to the disabled test file, taking no action; or
(2) when it is determined that the pull request includes at least one edit to the disabled test file, overwriting the at least one edit into the union content, before using the union content as a source of truth to disable and suppress tests in the code repository.

12. The method of claim 11, further comprising:
setting a maximum number of versions of the disabled test file associated with the target branch within the time period to fetch for generating the union content; and
fetching based on ages of the versions of the disabled test file within the time period from the oldest version until reaching the maximum number,
wherein the union content is generated based on the fetched versions of the disabled test file, when the maximum number is lower than a number of all versions of the disabled test file.

13. The method of claim 9, further comprising:
when determining that there is a version control outage or throttle, using content of the disabled test file as a source of truth to disable and suppress tests in the code repository.

14. The method of claim 9, wherein the one or more disabled tests associated with the target branch are tracked in a real-time or substantially real-time manner.

15. A non-transitory computer readable medium on which are stored instructions that, when executed, cause a programmable device to perform functions of:
tracking one or more disabled tests associated with a target branch of a code repository in a disabled test file;
after determining that a test in the target branch starts failing, receiving from a user device a pull request onto the target branch and blocking the pull request, the pull request invoking a build policy and a test policy;
after determining that the failing test in the target branch is disabled, tracking the disabled test in the disabled test file;
in response to a request from the user device to requeue the test policy received after the disabled test is tracked in the disabled test file, determining whether artifact in the build policy is identical with artifact in the test policy;
when it is determined that the artifact in the build policy is identical with the artifact in the test policy, fetching from the code repository a latest version of the disabled test file, and applying the requeued test policy using the latest version of the disabled test file as a source of truth to disable and suppress tests in the code repository; or
when it is determined that the artifact in the build policy is not identical with the artifact in the test policy, fetching from the code repository all versions of the disabled test file within a time period, generating a union content of all versions of the disabled test file, and applying the requeued test policy using the union content as a source of truth to disable and suppress tests in the code repository, the time period being between a start time of the build policy and a start time of the requeued test policy; and
unblocking the pull request.

16. The non-transitory computer readable medium of claim 15, wherein the instructions when executed, further cause the programmable device to perform functions of:
reenabling the disabled test in the target branch with a code fix, before requeuing the test policy.

17. The non-transitory computer readable medium of claim 16, wherein the instructions when executed, further cause the programmable device to perform functions of:
determining whether the pull request includes at least one edit to the disabled test file, and
(1) when it is determined that the pull request includes no edit to the disabled test file, taking no action; or
(2) when it is determined that the pull request includes at least one edit to the disabled test file, overwriting the at least one edit into the union content, before using the union content as a source of truth to disable and suppress tests in the code repository.

18. The non-transitory computer readable medium of claim 17, wherein the instructions when executed, further cause the programmable device to perform functions of:
setting a maximum number of versions of the disabled test file associated with the target branch within the time period to fetch for generating the union content; and
fetching based on ages of the versions of the disabled test file within the time period from the oldest version until reaching the maximum number,
wherein the union content is generated based on the fetched versions of the disabled test file, when the maximum number is lower than a number of all versions of the disabled test file.

19. The non-transitory computer readable medium of claim 15, wherein the instructions when executed, further cause the programmable device to perform functions of:
when determining that there is a version control outage or throttle, using content of the disabled test file as a source of truth to disable and suppress tests in the code repository.

20. The non-transitory computer readable medium of claim 15, wherein the one or more disabled tests associated with the target branch are tracked in a real-time or substantially real-time manner.
